(19) United States
(12) Patent Application Publication
(10) Pub. No.: US 2015/0049492 A1
(43) Pub. Date: Feb. 19, 2015

(54) PART OF A LED SYSTEM

(71) Applicant: DSM IP ASSETS B.V., Heerlen (NL)

(72) Inventors: Ronald Michaël Alexander Maria Schellekens, Echt (NL); Hans Klaas Van Dijk, Echt (NL)

(73) Assignee: DSM IP ASSETS B.V., Heerlen (NL)

(21) Appl. No.: 14/385,465

(22) PCT Filed: Mar. 14, 2013
(86) PCT No.: PCT/EP2013/055262

§ 371 Date: Sep. 15, 2014

(30) Foreign Application Priority Data
Mar. 16, 2012 (EP) 12159939.3

(51) Int. Cl. F21V 7/22; F21K 99/00; F21V 7/00

(52) U.S. Cl. CPC F21V 7/22; F21V 7/0066; F21K 9/54; F21Y 2101/02
USPC 362/341

(57) ABSTRACT

Part of a LED system being exposed to LED light, particular the reflector for a LED (light Emitting Diode) system, more particular the reflector for a mixing chamber of a LED system, which the part consists of a polymer composition comprising a polyester and a white pigment.

The inventions relates to a part of a LED system being exposed to LED light, particularly a reflector for a LED system, more particularly a reflector for a mixing chamber of a LED (light Emitting Diode) system.

LED systems may comprise a mixing chamber defined by a bottom reflector, a side reflector and a remote phosphor plate. LED's are in general mounted in the bottom reflector of the mixing chamber. Normally a LED produces blue light that is reflected by the side reflector and the bottom reflector and so transmitted through the remote phosphor plate, wherein the blue light is transformed into white light.

To obtain for instance a high luminous efficacy of the LED system, it is important that the reflectors for the LED system are of a highly reflective material. Known is a mixing chamber comprising a bottom and side reflector of a ceramic material. Ceramic materials are often chosen because of the high temperatures that occur in the mixing chamber, during use of the LED system. Furthermore the reflectors have an intense white color and a high reflectivity.

A disadvantage of such reflectors is however that their production process is complicated, so that the cost price of the reflectors is high. Furthermore the possibility to integrate parts in the reflector is limited. For that reasons attempts have been made to produce the reflectors, but also other parts of a LED system being exposed to LED light, of a polymeric material. However it appeared that the thermo-resistance of the polymeric material was insufficient to withstand the high temperatures of up to 80° C. or sometimes even up to 120° C., resulting for instance in loss of reflectivity during the use of the LED system in case of reflectors. It also appeared that polymeric materials discolor when they are exposed to LED light.

Object of the present invention is to provide a part of an LED system exposed to LED light of a polymer composition that maintains its color and/or a high reflectivity during the use of the LED system.

Surprisingly this object is obtained if the part consists of a polymer composition comprising a polyester and a white pigment.

It is highly surprising that the part according to the invention is not only resistant against the high temperatures, but that it is also highly resistant against the exposure to LED blue light.

The polyester may be polyethylene terephthalate, polybutylene terephthalate or polycyclohexylene terephthalate. Preferably the polyester is polyethylene terephthalate andor polybutylene terephthalate, most preferably polybutylene terephthalate.

### A. PBT.

Polybutylene terephthalate (PBT) may be produced from the polycondensation reaction of butane diol and terephthalic acid andor the methyl ester of terephthalic acid.

### B. PET.

Polyethylene terephthalate PET may be produced from the polycondensation reaction of ethylene diol and terephthalic acid andor the methyl ester of terephthalic acid. PBT and PET may comprise minor amounts, for example up to 5 wt. % of further monomer units, for example monomeric units of further alkylene diols and aromatic dicarboxylic acids.

The polymer composition comprises a white pigment. Examples of white pigments include titanium dioxide, zinc sulfide, zinc oxide, barium sulfate and potassium titanate. Preferably titanium dioxide is used.

Preferably the polymer composition contains
A. 80-100 pbw polyester, preferably PET andor PBT
B. 20-0 pbw of one or more further polymers, whereby A and B add up to 100 parts by weight (pbw),
C. 1-100 pbw of a white pigment.
D. 0-20 pbw of one or more further additives.

Preferably A is 80-100 pbw of polyester, preferably PET andor PBT, most preferably PBT, more preferably 90-100 pbw of polyester, preferably PET andor PBT, most preferably PBT, most preferably 98-100 pbw polyester, preferably PET andor PBT, most preferably PBT. This is because in this way a part for a LED system being exposed to LED light has a very high durability, resulting in a very high level of reflectivity andor maintenance of color.

Examples of further polymers include polycarbonate.

The polymer composition may contain one or more further additives, like for example processing aides, stabilizers, fillers, flame retardants mold release agents, etc. Preferably the composition contains 0-10 pbw of further additives.

The composition may further contain 0-30 wt. %, based on the total composition, of glass fibers.

Preferably the part of the LED sytem according to the invention is the reflector for a mixing chamber, more preferabl the side reflector. Even more preferably the side reflector and the bottom reflector of the mixing chamber are integrated into one molded part.

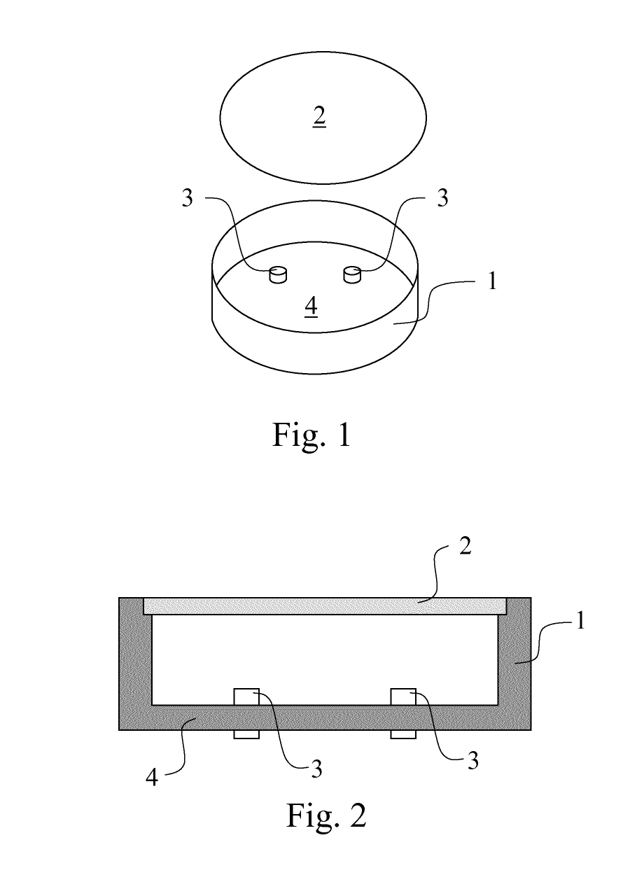

FIG. 1 shows a schematic view of a mixing chamber of a LED system.

FIG. 2 shows an intersection of the mixing chamber of FIG. 1.

The mixing chamber of FIG. 1 is defined by the side reflector (1), the bottom reflector (4) and the remote phosphor plate (2) that is lifted from the side reflector to provide a view inside the mixing chamber. In the bottom reflector 4 LED's are mounted, of which 2 LED's (3) are visible.

FIG. 2 shows an intersection of the mixing chamber of FIG. 1. The remote phosphor plate (2) is in its position on top of the mixing chamber. The side reflector (1) and the bottom reflector (4) are integrated into one molded part. Also shown are the LED's (3).

The invention is further explained by the examples.

### Materials Used:

PET: a polyethylene terephthalate with a relative solution viscosity of 1.34, measured according to ISO 1628-5 at a solution of 1 gram polymer dissolved in 125 grams dichloroacetic acid at 25° C.
PBT: Arnite ™ T04 200, polybutylene terephthalate delivered by DSM the Netherlands.
PA-46: Stanyl base polymer polyamide-4,6, delivered by DSM, the Netherlands.
PA-4T; For Tii, polyimide 4,T delivered by DSM, the Netherlands.
TiO2: R105, tanium dioxde, delivered by Dupont in Belgium.
Nucleating agent: sodium benzoate E11 delivered by Univar Benelux.

### Measurement of the Reflectivity.

The reflection was measured according to ISO 7724-1-2, using a Minolta ™ CM3700d spectrometer, at an angle of 460 nm.

### LED Blue Light Exposure.

Plaques of polymer compositions were exposed to LED blue light (455 nm). An OATAR LE W E3A module was used. Exposure was at a light intensity was 8klux, for 8 Hours at a temperature of 150° C. Judgment was whether a (dark) discoloration at the surface of the plaques was observed or not.

### Examples I and II, Comparative Experiment A, B

Mixtures of PET and PBT comprising 30 wt. % of titanium dioxide and 0.15 wt. % of sodium benzoate (examples I and II) and mixtures of PA-4,6 and PA 4T comprising 30 wt. % of titanium dioxide (comparative experiments A and, B) were prepared at a corotating twin screw extruder and injection molded in plaques of 80*80*2 mm. The reflectivity was measured at the initial samples and at the samples after 8 hours of accelerated aging at 150° C. Also the results after LED blue light exposure were determined as indicated above.

The results are presented in table 1.

TABLE 1

| | Reflection at | | LED blue |
|---|---|---|---|
| | 460 nm [%] | | light Dis- |
| Aging at 150° C. [h] | 0 hours | 8 hours | coloration |
| Ex I, PET, 30 wt. % TiO2 | 92.03 | 94.78 | No |
| Ex II, PBT, 30 wt. % TiO2 | 94.02 | 94.28 | No |
| Com. Exp. A, PA-46, 30 wt. % TiO2 | 94.70 | 90.40 | — |
| Com. Exp. B, PA-4T, 30 wt. % TiO2 | 93.1 | 90.3 | Yes |

From the results it is clear that the reflectivity of the samples comprising the polyester is constant or even increases, while the reflectivity of the polyamide declines as a function of exposure time. Furthermore it is clear that the polyesters are not sensitive for LED bleu light exposure, while the polyamide is.

1. Part of a LED system being exposed to LED light, the reflector consists of a polymer composition comprising a polyester and a white pigment.

2. Part according to claim 1, wherein the polyester is polyethylene terephthalate andor polybutylene terephthalate.

3. Part according to claim 1, wherein the white pigment is titanium dioxide, zinc sulfide, zinc oxide, barium sulfate and potassium titanate

4. Part according to claim 1, wherein the white pigment is titanium dioxide.

5. Part according to claim 1, wherein the polymer composition contains
A. 80-100 pbw polyester
B. 20-0 pbw of one or more further polymers, whereby A and B add up to 100 parts by weight (pbw),
C. 10-40 pbw of a white pigment.
D. 0-10 pbw of one or more further additives.

6. Part according to claim 1, wherein that the part is a reflector for a LED system.

7. Part according to claim 6, wherein the reflector is a side reflector for a mixing chamber of a LED system.

8. Part according to claim 6, wherein the side reflector is integrated with the bottom reflector into one molded part.
